(19) United States
(12) Patent Application Publication
(10) Pub. No.: US 2013/0133468 A1
(43) Pub. Date: May 30, 2013

(54) STEERING DEVICE FOR VEHICLES

(71) Applicant: GUSSI ITALIA S.R.L., Tregnago (IT)

(72) Inventor: Paolo RANCAN, BADIA CALAVENA (IT)

(73) Assignee: GUSSI ITALIA S.R.L., TREGNAGO (IT)

(21) Appl. No.: 13/684,974

(22) Filed: Nov. 26, 2012

(30) Foreign Application Priority Data
Nov. 24, 2011 (IT) VR2011A000208

(51) Int. Cl. B62D 1/04

(52) U.S. Cl. CPC B62D 1/04
USPC 74/552

(57) ABSTRACT

A steering device for vehicles, comprising a grip body which can be maneuvered by the user, is connected rotatably to the structure of a vehicle, about a rotation axis, and is connected functionally to elements adapted to impart a change of direction to the vehicle. At least one decorative element is associated with the grip body, bears at least one graphic marking and has, with respect to the structure of the vehicle, a preset reading position, in which the graphic marking can be read by the user. The device further comprises elements adapted to keep the decorative element in the reading position, independently of the angular position assumed by the grip body with respect to the structure of the vehicle about its rotation axis.

The present invention relates to a steering device for vehicles.

### BACKGROUND OF THE INVENTION

As is known, vehicles, such as cars, boats, aircraft and so forth, are provided with a steering device, which in fully general terms is constituted by a grip body that is connected rotatably to the vehicle structure about a rotation axis and can be maneuvered by the user in order to actuate, by means of a rotation thereof, a change of direction of the vehicle.

Such steering device is commonly termed steering wheel in the case of cars or rudder in the case of boats or aircraft.

The grip body of the steering device is usually formed by an external annular portion connected, by means of substantially radial spokes, to a central portion connected to the vehicle structure.

Typically, a decorative element is arranged on the grip body and more particularly on its central portion and a graphic marking, such as a logo and/or lettering, which usually identifies the manufacturer of the vehicle or of the steering device itself, is applied to the decorative element.

Generally, the supporting element is constituted by a disk which bears, on one of its faces, the graphic marking and, on the opposite face, is fixed rigidly to the grip body of the steering device.

In known steering devices, the graphic marking applied to the supporting element is therefore perfectly readable only when the grip body is, with respect to the vehicle structure, in a preset angular position, which normally corresponds to the angular position in which a straight trajectory is imparted to the vehicle.

### SUMMARY OF THE INVENTION

The aim of the present invention is to provide a solution to the problem described above, by providing a steering device for vehicles that allows the user to always be able to perfectly read the graphic marking arranged on the grip body of the steering device even when the grip body is turned.

Within this aim, an object of the invention is to provide a steering device that is reliable and practical to use.

Another object of the invention is to provide a steering device that has a very simple structure and a low cost.

This aim, as well as these and other objects that will become more apparent hereinafter, are achieved by a steering device for vehicles as defined in claim 1.

### BRIEF DESCRIPTION OF THE DRAWINGS

Further characteristics and advantages of the invention will become more apparent from the description of a preferred but not exclusive embodiment of the steering device for vehicles according to the invention, illustrated by way of non-limiting example in the accompanying drawings, wherein:

FIGS. 1, 2 and 3 are front elevation views of the steering device according to the invention in different angular positions with respect to its rotation axis;

FIG. 4 is an enlarged-scale sectional view of a detail of the steering device according to the invention;

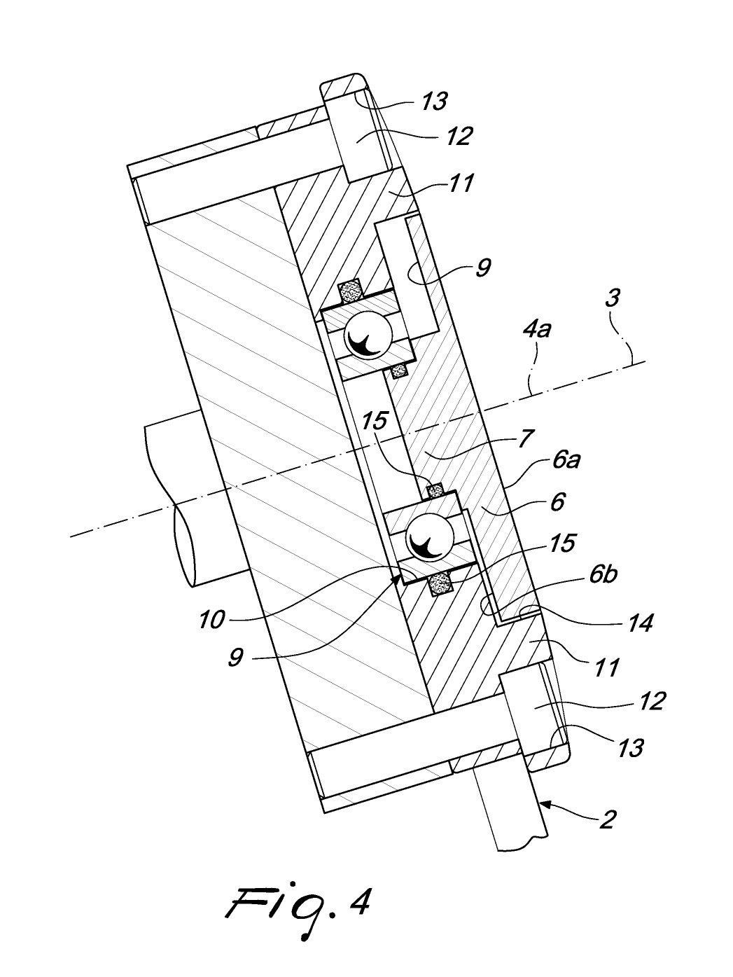

FIG. 5 is an exploded perspective view of some components of the steering device according to the invention.

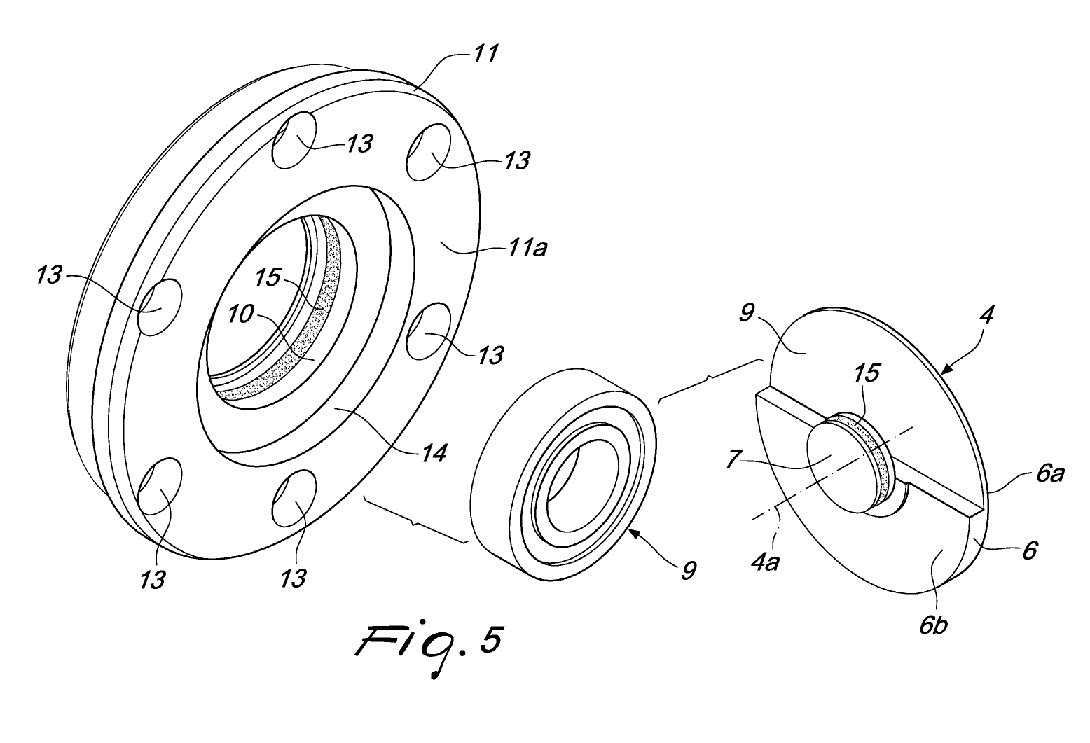

### DESCRIPTION OF THE PREFERRED EMBODIMENTS

With reference to the cited figures, the steering device for vehicles according to the invention, generally designated by the reference numeral 1, comprises a grip body 2, which can be maneuvered by the user and is connected, so that it can rotate about a rotation axis 3, to the structure of a vehicle, such as for example a boat, a car, an aircraft and the like.

In particular, the grip body 2 is connected functionally to means known per se and adapted to impart a change of direction to the vehicle as a consequence of an angular movement of the grip body 2 about its own rotation axis.

By way of example, the grip body 2 can have an external annular portion 2a, which is designed to be gripped by the user, and a central portion 2b, which is connected to the vehicle structure and joined to the outer annular portion 2a by means of spokes 2c, which are distributed around the central portion 2b.

Moreover, at least one decorative element 4 is associated with the grip body 2 and supports at least one graphic marking 5, which can be constituted for example by a logo and/or by lettering or others and in general has the function of indicating the manufacturer of the vehicle or of the steering device.

The decorative element 4 has, with respect to the structure of the vehicle, a preset reading position, in which the graphic marking 5 is perfectly readable by the user.

The particularity of the invention resides in the fact that it comprises means adapted to keep the decorative element 4 in said position for reading of the graphic marking 5, independently of the angular position assumed by the grip body 2 about its own rotation axis 3 with respect to the vehicle structure.

With reference to the illustrated embodiment, the decorative element 4 can rotate freely, with respect to the grip body 2, about an oscillation axis 4a, which is substantially parallel to the rotation axis 3 of the grip body 2 and furthermore has an eccentric mass, with respect to its oscillation axis 4a, so that its center of gravity is spaced from its oscillation axis 4a.

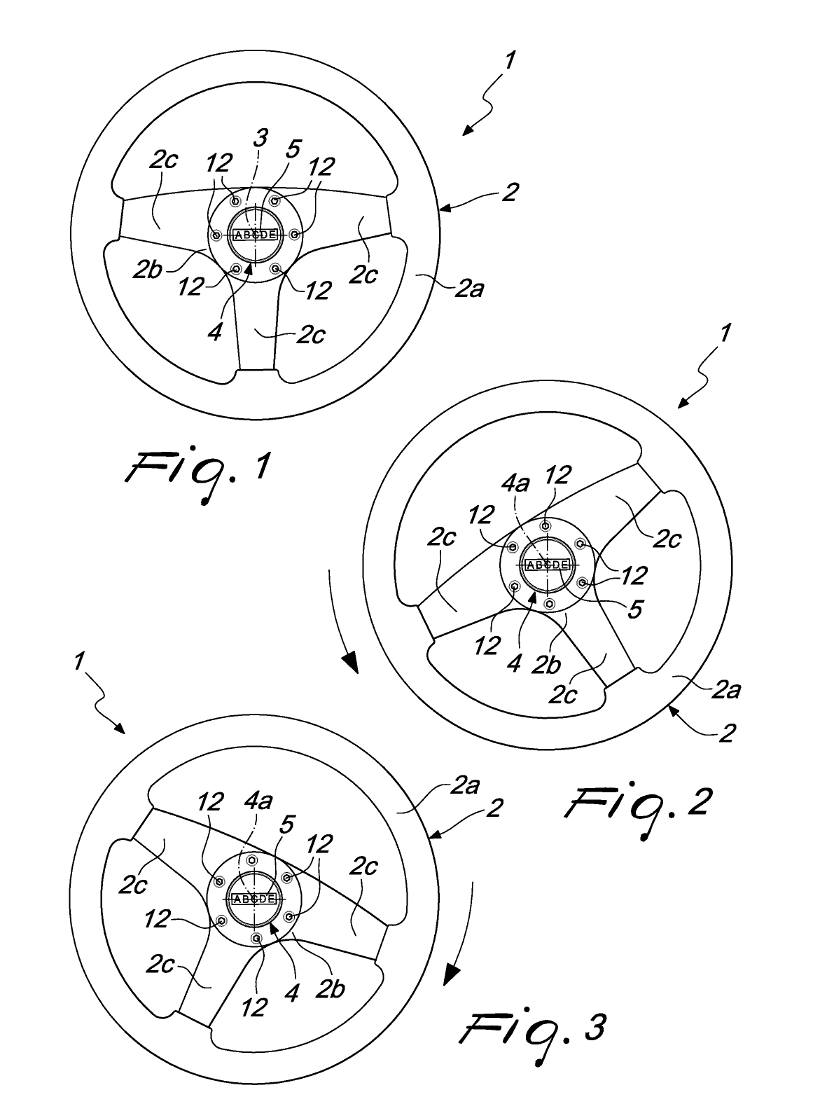

In this case, the rotation axis 3 of the grip body 2 is inclined with respect to the vertical, so that the decorative element 4 can remain, due to gravity, in the position for reading of the graphic marking 5 even when the user turns the grip body 2 about the rotation axis 3, as shown in FIGS. 1, 2 and 3.

Delving further into the details of such embodiment, the decorative element 4 conveniently comprises a base body 6 which is substantially disc-shaped and bears, on a face 6a thereof that is directed toward the user, the graphic marking 5.

The base body 6 is mounted so that it can rotate freely about its own axis on the grip body 2, so that the oscillation axis 4a of the decorative element 4 practically coincides with the axis of the base body 6.

Advantageously, in the base body 6 there is, at a peripheral region thereof, a lightening hollow 9, which in practice provides the base body 6 with a mass that is eccentric with respect to its own axis, about which it is intended to rotate. The lightening hollow 9 conveniently opens onto the face 6b of the base body 6 that lies opposite the one that bears the graphic marking 5.

It should be noted that as a replacement of or in combination with the lightening hollow 9, it is also possible to provide the base body 6 with an additional mass arranged in a peripheral position, so as to always achieve a spacing of the center of gravity of the base body 6 from the axis about which it is intended to rotate.

Also on its face 6b thereof that lies opposite the face directed toward the user, the base body 6 is provided with an axial rotation pivot 7, which is advantageously supported so that it can rotate by the grip body 2 by virtue of the interposition of a rolling bearing 8, which ensures the rotation of the base body 6 with respect to the grip body 2 without requiring lubrication interventions and without the risk of deterioration due to wear, thus ensuring high reliability.

Conveniently, the rolling bearing 8 is accommodated in a seat 10 that is formed in a supporting ring 11, which is fixed to the grip body 2, for example by means of screws 12 accommodated in holes 13 distributed around its axis.

Conveniently, in the supporting ring 11 there is also, around the seat 10, a slot 14 designed to receive the base body 6, so that the face 6a thereof is substantially flush with the axial face 11a of the supporting ring 11 that is designed to be directed toward the user, so as to achieve greater compactness of the assembly.

Advantageously, the supporting ring 11 in turn is recessed in a corresponding accommodation region, formed in the central portion 2b of the grip body 2, so that its axial face 11a can be substantially flush with the outer surface of the grip body 2.

Advantageously, the coupling between the axial rotation pivot 7 of the base body 6 and the rolling bearing 8 and between the rolling bearing 8 and the supporting element 11 is performed by pressing so as to avoid the use of screws or the like. To ensure the coupling, elastic retention rings 15 are provided which are formed in practice by O-rings and are interposed respectively between the supporting ring 11 and the rolling bearing 8 and between the rolling bearing 8 and the axial rotation pivot 7 of the base body 6.

As is shown, the base body 6 can be arranged conveniently so that its axis substantially coincides with the rotation axis 3 of the grip body 2.

The operation of the steering device according to the invention is as follows.

When the grip body 2 is arranged, with respect to the vehicle structure, in its angular position, about its own rotation axis 3, that corresponds to a rectilinear path of the vehicle, the decorative element 4 is arranged in the position for reading the graphic marking 5 and so that its center of gravity lies below its oscillation axis 4a.

Upon a rotation of the grip body 2 about its own rotation axis 3 that is imparted by the user in order to change the direction of the vehicle, the decorative element 4, by being able to rotate about the oscillation axis 4a with respect to the grip body 2, remains in its initial position with respect to the fixed structure of the vehicle, i.e., in the position for reading the graphic marking 5, due to the gravitational force that acts on its eccentric mass, and tends to keep its center of gravity in a position that lies below its oscillation axis 4a.

In practice it has been found that the invention is capable of fully achieving the intended aim and objects.

All the characteristics of the invention indicated above as advantageous, convenient or the like may also be omitted or be replaced with equivalents.

The individual characteristics presented with reference to general teachings or to particular embodiments can all be present in other embodiments or can replace characteristics in these embodiments.

The invention thus conceived is susceptible of numerous modifications and variations, all of which are within the scope of the inventive concept.

In practice, the materials used, as well as the shapes and dimensions, may be any according to the requirements.

All the details may furthermore be replaced with other technically equivalent elements.

The disclosures in Italian Patent Application No. VR2011A000208 from which this application claims priority are incorporated herein by reference.

What is claimed is:

1. A steering device for vehicles, comprising a grip body which can be maneuvered by the user, is connected rotatably to the structure of a vehicle, about a rotation axis, and is connected functionally to means adapted to impart a change of direction to said vehicle, at least one decorative element being associated with said grip body, supporting at least one graphic marking and having, with respect to the structure of said vehicle, a preset reading position, in which said at least one graphic marking can be read by the user, the device further comprising means adapted to keep said decorative element in said reading position, independently of the angular position assumed by said grip body with respect to the structure of the vehicle about said rotation axis.

2. The steering device according to claim 1, wherein said decorative element can rotate freely, with respect to said grip body, about an oscillation axis which is substantially parallel to said rotation axis and has a mass which is eccentric with respect to said oscillation axis, said rotation axis being inclined with respect to the vertical.

3. The steering device according to claim 1, wherein said decorative element comprises a substantially disk-like base body, which is mounted so that it can rotate freely about its own axis on said grip body and has a face which is directed toward the user and is provided with said at least one graphic marking.

4. The steering device according to claim 3, wherein said base body has a lightening hollow at one of its peripheral regions.

5. The steering device according to claim 3, wherein said base body has, on its face which is opposite to the one directed toward the user, an axial rotation pivot which is connected rotatably to said grip body through the interposition of a rolling bearing.

6. The steering device according to claim 5, wherein said rolling bearing is accommodated in a seat which is formed in a supporting ring fixed to said grip body.

7. The steering device according to claim 3, wherein said base body is arranged so that its axis substantially coincides with said rotation axis of said grip body.

8. The steering device according to claim 5, wherein said axial rotation pivot, said rolling bearing and said supporting ring are mutually coupled by pressing.

9. The steering device according to claim 6, wherein elastic retention rings are interposed between said axial rotation pivot and said rolling bearing and between said rolling bearing and said supporting ring.
